(19) United States
(12) Patent Application Publication
(10) Pub. No.: US 2008/0028634 A1
(43) Pub. Date: Feb. 7, 2008

(54) METHOD FOR USING HEAT FROM COMBUSTION TURBINE EXHAUST TO DRY FUEL FEEDSTOCKS

(75) Inventor: James Francis Leahy, Tulsa, OK (US)

Correspondence Address: BUSKOP LAW GROUP, P.C., 4511 Dacoma Street, HOUSTON, TX, 77092, US

(73) Assignee: SYNTROLEUM CORPORATION, Tulsa, OK (US)

(21) Appl. No.: 11/856,413

(22) Filed: Sep. 17, 2007

Related U.S. Application Data
(63) Continuation-in-part of application No. 11/499,938, filed on Aug. 7, 2006, now Pat. No. 7,271,201.

(51) Int. Cl. F26B 3/02

(52) U.S. Cl. 34/480; 432/14; 60/320

(57) ABSTRACT

A system for drying fuel feedstocks, comprising a heat exchanger to heat an initial nitrogen gas and a combustion turbine engine for producing a combustion turbine exhaust. An apparatus for forming a pulverized fuel receives the heated nitrogen gas and combustion turbine exhaust, forming a steam and nitrogen mixture with the pulverized fuel source. A filter receives the mixture for filtering the dried fuel feedstock from the steam and nitrogen. The system further comprises a blower for applying a vacuum to the filter to separate the steam and nitrogen mixture into a discharge stream for and a recycle stream for mixing with additional dry nitrogen gas prior to mixing with combustion turbine exhaust in a continuous process.

### CROSS REFERENCE TO RELATED APPLICATIONS

The patent application is a continuation-in-part application that claims the benefit, under 35 USC §120, of the co-pending non-provisional U.S. application Ser. No. 11/499,938, which was filed Aug. 7, 2006. The prior co-pending non-provisional application is incorporated by reference along with its appendices

### FIELD

The present embodiments generally relate to a method for using heat from a combustion turbine exhaust to dry fuel feedstocks.

### BACKGROUND

Refineries and plants, such as those that perform Fischer-Tropsch reactions, can produce a large amount of heat, which is typically released into the environment as waste heat without recycling, and can contribute to thermal pollution.

Use of dry fuel feedstock achieves higher yields of hydrogen and carbon monoxide and lower yields of carbon dioxide than wet fuel feedstock in gasification processes. However, drying is a utility-intensive operation that can consume fuel worth as much as 50% of the value of the dry fuel feedstock.

A need exists for a method of using waste heat to heat materials in another process, such as the drying of fuel feedstocks, creating a more environmentally friendly method that substantially reduces thermal emissions into the environment, thus protecting the environment.

A need also exists for a method to reduce demand for fossil fuels by offering a low cost alternative to the use of natural gas for the production of hydrogen for fuel and other products, by enabling the use of cheaper coal stocks or biomass that can be used in gasification processes.

A need exists for an energy-efficient method that facilitates use biomass of as a fuel for gasification processes to reduce new carbon dioxide emissions to the environment.

A need exists for a low cost, or environmentally friendly fuel feedstock drying method for use in gasification plants.

The present embodiments meet these needs.

### BRIEF DESCRIPTION OF THE DRAWINGS

The detailed description will be better understood in conjunction with the accompanying drawings as follows:

FIG. 1 depicts a diagram showing the steps of an embodiment of the present method.

FIG. 2 depicts a schematic of a pulverized fuel treatment system operated in conjunction with a Fischer-Tropsch reactor.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

The present method advantageously provides a fuel-efficient means for producing a dry fuel feedstock, such as coal, biomass, or combinations thereof. Conventional drying processes require large quantities of fuel, such as flue gas from an incinerator, and often require more nitrogen gas than what can be readily provided. Conventional drying can consume fuel worth as much as 50% of the value of the dry fuel feedstock and can require nitrogen gas in excess of what is typically available from an air separation plant used to produce the oxygen needed for gasification. The present method uses combustion turbine exhaust to heat conveying gasses, saving over 900,000 Btu (LHV) per ton of lignite coal dried, compared to use of incinerator flue gas.

The present method is also advantageously continuous. At least a portion of the heated gas used to dry the fuel source and convey the dry fuel feedstock can be recycled and reused to dry and convey additional feedstock. Use of recycled gas conserves additional nitrogen and the fuel required to heat the additional nitrogen. The yield of hydrogen and carbon monoxide from the gasification process is also increased.

The present method beneficially reduces thermal emissions, by allowing for the use of waste heat, such as heat from Fischer-Tropsch synthesis reactions and/or heat from combustion turbine exhaust, to dry fuel feedstock. Heat that would otherwise be released into the atmosphere in the form of steam is captured and flowed through to a heat exchanger where energy is recovered for use in the drying of fuel feedstocks. Energy and matter in the form of combustion turbine exhaust is captured for reuse in the same drying process.

Use of combustion turbine exhaust is uniquely beneficial due to the fact that the combustion turbine exhaust provides a large quantity of mass into which moisture from fuel feedstocks can evaporate. Conventional drying methods require large quantities of inert gas to dry fuel feedstocks, which the present system overcomes through use of combustion turbine exhaust together with significantly smaller quantities of nitrogen. Use of combustion turbine exhaust enables any remaining nitrogen needs to be met by an air separation unit sized to produce oxygen for gasification.

The present method provides an advantageous alternative to fossil fuels by facilitating the gasification of biomass, which can include wet agricultural wastes, such as chips, grasses, and corn waste, where avoidance of water in the feed is of special importance. Many biomass feedstocks exhibit high moisture content, and many types of biomass exhibit a low heating value due to high oxygen content. Agricultural wastes have been traditionally unusable as a fuel unless dried, which can require a long span of time in the sun, or use of electric blowers or similar equipment that obtains power from fossil fuels, making the use of biomass extremely expensive and energy-inefficient. The present method can be used for drying biomass feedstocks in an energy-efficient manner, using waste heat and recycled heat.

The present method thereby effectively produces a dry biomass feedstock, which provides a greenhouse gas neutral fuel, which advantageously does not increase a facility's accountability for new carbon dioxide emissions.

The present method also enables wet coal dust to be dried in a manner which is generally cheaper in cost than currently used means. In this manner, the yield of hydrogen and carbon monoxide from the gasification process is increased.

The present embodiments relate to a method for using heat from a combustion turbine exhaust to dry fuel feedstocks, such as coal feedstock, biomass feedstock, or combinations thereof, by removing water from the fuel.

Water is undesirable in gasification feedstocks, as wet fuel feedstocks will not produce gasification temperatures or carbon monoxide yields as high as dry coal. However, water-reduced coal, water-reduced biomass, or combinations thereof are desirable, even if as much as six to twelve percent water by weight remains.

The present method reduces the water content of fuel feedstocks to less than about 10%, and as low as about 8% or lower, by removing from about 5% water by weight to about 35% water by weight, or more, from the fuel feedstocks. The percent by weight of the water is defined as the amount of water per unit mass of a feedstock quantity.

The fuel source is contemplated to be dried using a heat source, which can include waste heat, such nitrogen heated by steam from a Fischer-Tropsch reaction of high molecular weight hydrocarbon mixtures and/or exhaust from a combustion turbine.

The method includes forming an initial nitrogen gas, which can be formed using an air separation plant or similar air separation facility. The initial nitrogen gas is heated to a temperature ranging from about 212 degrees Fahrenheit to about 350 degrees Fahrenheit, forming a heated nitrogen gas.

In an embodiment, the heating can be performed using steam produced by Fischer-Tropsch synthesis. The heating can be performed using a heat exchanger, which can include a shell and tube heat exchanger, such as such as one made by Cust-O-Fab of Sand Springs, Okla., a fin-fan heat exchanger, a welded plate and frame heat exchanger, such as such as those made by Tranter, Incorporated of Wichita Falls, Tex., or other similar heat exchangers.

Combustion turbine exhaust, which can be produced by a combustion turbine engine, such as a gas engine, a turboshaft engine, a radial gas turbine, or other similar combustion turbine engines.

The combustion turbine exhaust can be recovered directly from the turbine or from a Heat Recovery Steam Generator (HRSG). It is contemplated that any reduction of the heat recovered by a HRSG can be offset by the savings in fuel provided by using the combustion turbine exhaust to create a dry fuel feedstock in lieu of fueling an incinerator. The savings of low-sulfur fuel achieved by use of combustion turbine exhaust to dry lignite coal is approximately 901,591 Btu (LHV) per ton of lignite dried. The corresponding loss of recovered HRSG steam is approximately 658,531 Btu per ton of lignite, which is contemplated to have a power recovery rate of approximately 17,065 Btu per kWh. Thus, the loss of steam turbine driven power production is more than offset by the fuel savings.

Both the combustion turbine exhaust and the heated nitrogen gas are conveyed to an apparatus for forming a pulverized fuel. The apparatus can include a crusher/classifier for receiving, crushing, and classifying coal, such as a MPS vertical mill made by Gebrudder Pfeiffer AG (Gebr. Pfeiffer AG) of Germany or a vertical roller mill for coal with classifiers made by Alstrom of France. The apparatus can also include a biomass pulverizer for receiving and forming biomass particles. Combinations of coal crusher/classifiers and biomass pulverizers can be used when a fuel source containing both coal and biomass is pulverized.

The heated nitrogen gas, the combustion turbine exhaust, and a pulverized fuel are mixed in the apparatus for forming a pulverized fuel, thereby forming a gas/particulate mixture having a temperature of at least 572 degrees Fahrenheit. The pulverized fuel source is suspended in the gas as it heats and dries, forming a gas/particulate mixture of nitrogen, steam, and pulverized fuel.

The momentum of the gas/particulate mixture can be used to convey the gas/particulate mixture to a filter. The gas/particulate mixture is then filtered, forming a stream of steam and nitrogen and a dried fuel feedstock. The filtering can be performed using one or more bag filters, such as those made by U.S. Air Filtration, Incorporated of Temecula, Calif., having one or more flow insertion wands for pulsing the filter bags at periodic intervals.

The present method then includes separating the stream of steam and nitrogen into a discharge stream and a recycle stream. The discharge stream can be released into the atmosphere, while the recycle stream can be mixed with additional nitrogen to be used as the initial nitrogen gas for mixing with combustion turbine exhaust in a continuous process.

In an embodiment, the flow rates of the initial nitrogen gas, the heated nitrogen gas, the combustion turbine exhaust, the gas/particulate mixture, the stream of steam and nitrogen, the discharge stream, the recycle stream, or combinations thereof can range from about 80,000 cubic feet to about 300,000 cubic feet per ton of pulverized fuel.

In an embodiment, the oxygen content of the gas/particulate mixture can be limited by combusting a fuel, such as a clean, low sulfur fuel, in the combustion turbine exhaust stream, thereby depleting the oxygen content of the combustion turbine exhaust. The combustion also raises the temperature of the gas/particulate mixture.

During start-up, the heated nitrogen gas can be mixed with incinerator flue gas in the apparatus for forming pulverized fuel. It is contemplated that use of incinerator flue gas can continue until sufficient recycled conveying gas exists to forego use of the standby incinerator. A standby incinerator can also be selectively activated to control oxygen content within the conveying gasses. An exemplary incinerator can be one made by Mac, Incorporated of Glenburn, Ohio.

The present method can further include the step of pulverizing the fuel, which can be done using the apparatus for forming a pulverized fuel.

The dried fuel feedstock can be collected using gravity. Manual, mechanical, and automatic means to collect the dried fuel feedstock are also contemplated. A dry feedstock silo, or other similar containing apparatus, can be used for receiving dried fuel feedstock after filtration. In an embodiment, the filter can also be a storage vessel for the dried fuel feedstock.

In a contemplated embodiment, the stream of steam and nitrogen can be removed from the filter using a vacuum pump. It is contemplated that a sufficient vacuum of about 0.005 bars of vacuum to 0.100 bars of vacuum can be applied using a blower, which can be a centrifugal blower or a squirrel caged blower, such as those available from Gardner Denver of Quincy, Ill., or other similar blowers. Other vacuum pumps can also be used. A vacuum can also be applied to the pulverized fuel source during heating to facilitate conveyance of the gases.

One or more fans can also be used to facilitate the flow of conveying gas and pulverized fuel source from the pulverizing apparatus through the filter.

The separation of the stream of steam and nitrogen can be done using the vacuum pump. Use of a blower raises the pressure of the stream of steam and nitrogen, allowing a first portion to be discharged to the atmosphere, and a second portion to be mixed with additional nitrogen gas.

The additional nitrogen gas can be from the same source as the initial nitrogen gas, or from a different source. It is contemplated that additional nitrogen can be pre-mixed with the recycle stream in tubing, or a similar vessel, prior to repeating the process using the recycle stream.

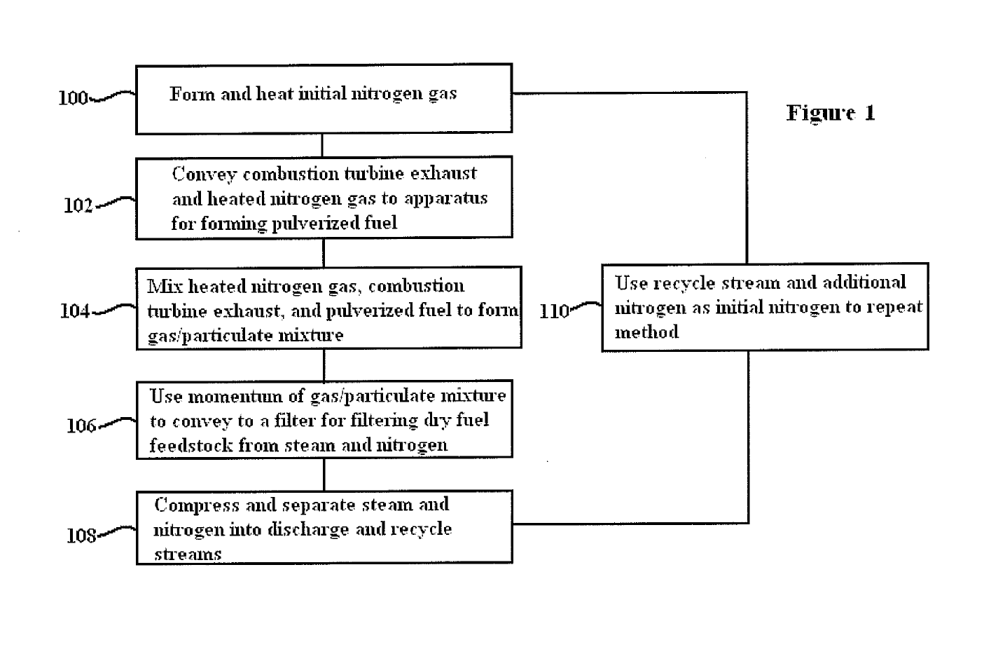

Referring now to the Figures, FIG. 1 depicts a diagram showing the steps of an embodiment of the present method.

The depicted embodiment begins by forming and heating an initial nitrogen gas 100. This step is contemplated to raise the temperature of the initial nitrogen gas to a temperature ranging from about 212 degrees Fahrenheit to about 350 degrees Fahrenheit, forming heated nitrogen gas. The heating can be performed using heat from a Fischer-Tropsch synthesis reaction.

The heated nitrogen gas and combustion turbine exhaust are then conveyed to an apparatus for forming a pulverized fuel 102. In the apparatus, the heated nitrogen gas, the combustion turbine exhaust, and the pulverized fuel are mixed to form a gas/particulate mixture 104. This step is contemplated to raise the temperature of the nitrogen to at least 572 degrees Fahrenheit, but less than a temperature that would ignite or cause thermal degradation of pulverized biomass. This step can be performed under a slight vacuum to facilitate drying and conveyance of the pulverized fuel source. A fan or other blowing apparatus can be used to further facilitate conveyance of the gas/particulate mixture.

The depicted embodiment can further include using the momentum of the gas/particulate mixture to convey the gas/particulate mixture to a filter for filtration of the dry fuel feedstock from the steam and nitrogen 106. This step can also be performed under a slight vacuum to facilitate conveyance and filtration of the gas/particulate mixture. The filtration can be performed using one or more bag filters or similar filtering means. It is contemplated that at least one flow insertion wand can be used to pulsate each bag filter periodically, such as every thirty seconds, to loose dried fuel feedstock that is trapped in the bag filters. The dry fuel feedstock can be collected using gravity, manual means, or mechanical means, in a silo or a similar containment vessel.

The steam and nitrogen stream is then compressed and separated into a discharge stream and a recycle stream 108. The discharge stream is contemplated to be discharged into the atmosphere. The recycle stream can be mixed with additional nitrogen and used as the initial nitrogen gas to repeat the method 110. The present method can thereby be performed continuously, requiring reduced quantities of additional heat and nitrogen due to the use of the recycle stream.

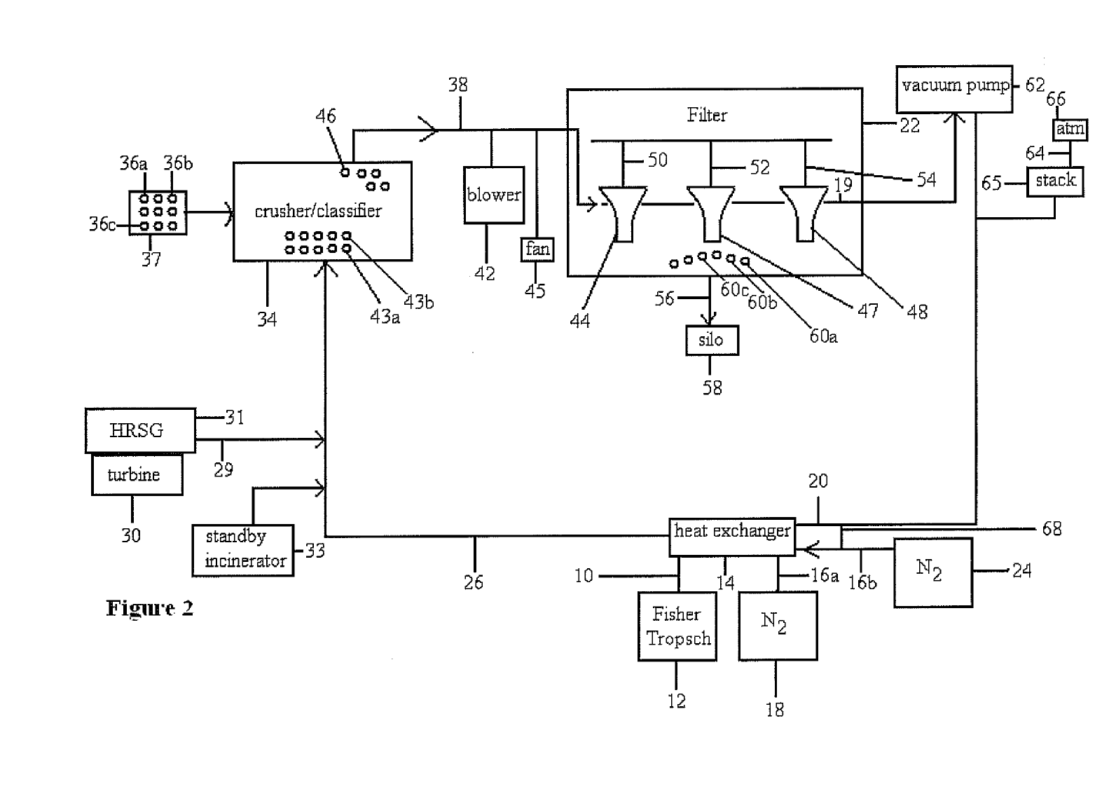

FIG. 2 depicts an embodiment of a system useable with the present method, showing a schematic of a coal feedstock pretreatment system operated in conjunction with a Fischer-Tropsch reactor for preparing coal feedstocks. The same system can be used for preparing biomass feedstocks. However, the coal crusher classifier 34 would be replaced with a pulverizer for mashing, shredding, and cutting the biomass grasses, wood ships, or other matter. The coal crusher classifier and the pulverizer will be generally referred to herein as “apparatus for pulverizing a fuel source.”

FIG. 2 depicts steam 10 from a Fischer-Tropsch reactor 12, passed to a heat exchanger 14. A usable heat exchanger can be a shell and tube heat exchanger, a fin-fan heat exchanger, or a welded plate and frame heat exchanger, such as those made by Tranter, Incorporated of Wichita Falls, Tex.

The heat exchanger 14 additionally receives initial nitrogen gas 16a, from an initial nitrogen source 18, which can be an air separation facility or another type of nitrogen source. In an embodiment, it is contemplated that after start-up, the initial nitrogen gas can be replaced by recycle stream 20 of steam and nitrogen mixture 19, recycled by the system. In this embodiment, the heat exchanger 14 can receive a mix of additional nitrogen gas 16b from an additional nitrogen source 24 with recycle stream 20.

Additional nitrogen source 24 can be the same type of source as initial nitrogen source 18, or a different type of nitrogen source. In an embodiment, it is also contemplated that additional nitrogen source 24 and initial nitrogen source 18 can be the same nitrogen source, providing nitrogen gas both on start-up to steam 10 and during operation to recycle stream 20.

The initial nitrogen gas can be either generally pure, 100% dry nitrogen gas or a dry mixture of nitrogen with about 4 wt % t to about 8 wt % by weight oxygen gas based on the total content of the mixture.

The heat exchanger 14 uses the steam 10 from the Fischer-Tropsch reactor 12 to heat the initial nitrogen gas 16a to a temperature ranging from about 212 degrees Fahrenheit to about 350 degrees Fahrenheit.

After startup, the heat exchanger 14 can use the steam 10 from the Fisher-Tropsch reactor 12 to heat the mixture of recycle stream 20 with initial nitrogen gas 16a, additional nitrogen gas 16b or combinations thereof, forming heated nitrogen gas 26.

The heated nitrogen gas 26 is received by a coal crusher classifier 34, where heated nitrogen gas 26 can be heated by combustion turbine exhaust 29 conveyed into the coal crusher classifier 34 from a combustion turbine 30. In an embodiment, a standby incinerator 33 can be used to provide flue gas for heating heated nitrogen gas 26.

The mixing of combustion turbine exhaust 29 with the heated nitrogen gas 26 in the coal crusher classifier 34 yields a gas mixture having a temperature of at least 572 degrees Fahrenheit. Combustion turbine 30 is shown having a Heat Recovery Steam Generator stack 31, which can be used to discharge HRSG exhaust into the atmosphere or to pass the combustion turbine exhaust 29 to the coal crusher classifier 34.

The coal crusher classifier 34 is contemplated to be a device that receives lumps of coal 36a, 36b and 36c from a coal receptacle 37. The lumps of coal 36a, 36b and 36c typically contain some water, causing the coal crusher classifier 34 to pulverize the lumps of coal 36a, 36b and 36c into wet coal dust. A usable crusher classifier can be a MPS vertical mill made by Gebrudder Pfeiffer AG (Gebr. Pfeiffer AG) of Germany. Vertical roller mills for coal with classifiers made by Alstrom of France are also contemplated herein. It is contemplated that any type of crusher or milling device with a classifier for coal can be used. Similar processing apparatuses for biomass can also be used.

The coal crusher classifier 34 receives the heated nitrogen gas 26 and the combustion turbine exhaust 29 and passes the gasses through the pulverized and classified wet coal. This activity vaporizes water from the wet coal and forms a mixture of nitrogen, steam, and pulverized fuel source, which FIG. 1 also depicts as ground coal dust 46.

The combustion turbine 30 and heat exchanger 14 are maintained in communication with the coal crusher classifier 34 using tubing or similar connection means that is also in communication with a blower 42 or fan 45, which draws the gasses through the coal crusher classifier 34 using the momentum of the hot gasses to convey ground coal dust 46 while permitting crushed larger particles of coal 43a an 43b to gather in the base of the coal crusher classifier 34 to be crushed further.

The heated nitrogen gas and ground coal dust mixture 38 can be passed to a filter 22. FIG. 2 depicts filter 22 as a vessel containing bag filters 44, 47 and 48. Each bag filter 44, 47 and 48 is shown having a flow insertion wand 50, 52 and 54 for pulsing each bag filter 44, 47 and 48, enabling the dried fuel feedstock to fall to the bottom of the filter 22 vessel.

While FIG. 2 depicts only three bag filters, a usable filter 22 is contemplated to hold from about 50 filtering bags to about 500 filtering bags, or more. A contemplated embodiment includes a filter having 100 filtering bags. It is contemplated that fewer bag filters can be used for smaller flow rate gasses with lower velocities, while a larger number of bag filters would be needed for higher velocities.

The filter 22 can use bag filters having a pore size ranging from about 5 microns to about 50 microns, such as those made by Gore Tex Company of Newark, Del. The bag filters 44, 47 and 48 enable the heated nitrogen gas and ground coal dust mixture 38, containing coal dust, steam, and nitrogen to flow into the bags, causing dried fuel feedstock to be collected on the outside of the bag filters 44, 47 and 48. The gas can then pass out of the filter 22 as clean nitrogen and steam without particles.

The flow insertion wands 50, 52 and 54 pulse the bag filters periodically, causing dried coal dust 60a, 60b and 60c on the exterior of the bag filters 44, 47 and 48 to fall to the bottom of the filter 22 for removal. It is contemplated that each bag filter can hold from about 10 liters to about 50 liters of gas, and each filter bag can have a shape of a wind sock. The filter 22 can have a filter housing made of metal, to prevent deformation in the presence of hot steam and hot gasses. The bag filter housing can be made from steel, stainless steel, or another metal alloy that can withstand the impact and temperature of the coal dust and steam without degrading.

Dried pulverized coal feedstock 56 is removed from the filter 22 using gravity and collected in a silo 58. Other types of containers besides silos can also be used to collect the dried pulverized coal feedstock 56.

A vacuum pump 62, can be used to apply a vacuum to the filter 22 such as a vacuum ranging from about 0.005 bars of vacuum to about 0.100 bars of vacuum, to evacuate the steam and nitrogen mixture 19 from the filter 22.

The steam and nitrogen mixture 19 can be separated into two streams, a discharge stream 64 comprising steam and nitrogen for discharge into the atmosphere 66 via a stack 65, and a recycle stream 20 of steam and nitrogen, which can be recycled back to the heat exchanger 14.

The recycle stream 20 can be mixed with additional nitrogen gas 16b from an additional nitrogen source 24 at the heat exchanger 14, or premixed in a vessel or tubing 68, forming a mixture of hot, moderately wet nitrogen with additional dry nitrogen gas, for flowing into the heat exchanger 14 to repeat the process.

The flow rate for the entire system depicted in FIG. 2 is contemplated to range from about 80,000 cubic feet to about 300,000 cubic feet of gas mixture per ton of coal.

Alternative embodiments contemplate using a blower instead of a vacuum pump 62 that can be a centrifugal blower or a squirrel caged blower adapted to provide between about 0.005 bars of vacuum to about 0.100 bars of vacuum on the filter 22. These types of blowers are available from Gardner Denver of Quincy, Ill.

The present method contemplates producing a pulverized fuel source that contains from about 8% to about 10% absorbed water by weight. The pulverized fuel source can include combinations of wet pulverized coal and pulverized biomass, such as a mixture having from about 3% to about 10% biomass, or up 20% of pulverized biomass. In a contemplated embodiment, the pulverized fuel source can have about 95% particulate smaller than about 400 microns in diameter and about 50% particulate smaller than about 200 microns in diameter.

Pulverized biomass can include wood chips, switch grass, corn stover or corn stalks, bagasse from sugar cane, another leafy plant matter, or combinations of these items.

In another embodiment, the twice heated nitrogen gas can be passed through the pulverized fuel source at a flow rate ranging from about 80,000 cubic feet to about 300,000 cubic feet per ton of pulverized fuel source. It is also contemplated that the pulverized fuel source can be placed under a slight vacuum during heating.

An embodiment will now be described with reference to the following example,

### EXAMPLE 1

A slurry bubble column Fischer-Tropsch reactor having a mixture of cobalt catalyst and wax receives synthesis gas and exothermically provides heat. Water is boiled in coils in this column forming steam.

Steam from the Fischer-Tropsch reactor is transferred to a shell and tube heat exchanger, such as one made by Cust-O-Fab of Sand Springs, Okla.

Nitrogen gas and a recycled steam and nitrogen mixture are injected into the shell and tube heat exchanger and heated by the steam of the Fischer-Tropsch reactor without mixing with the steam.

The heated mixture of nitrogen gas and the recycled steam and nitrogen mixture is then mixed with a combustion turbine exhaust produced from a combustion turbine, which further raises the temperature of the combined mixture of the nitrogen gas and recycled steam and nitrogen to about 572 degrees Fahrenheit, which forms a hot gas mixture.

The mixing of the heated nitrogen gas and the combustion turbine exhaust occurs upstream of a coal crusher/classifier.

The hot gas mixture blows through the crushed coal, upwards against gravity, entraining fine coal dust. The blowing gas permits larger coal particles to fall to the bottom of the crusher/classifier to be crushed into finer and smaller sizes. The process is continued until only fine coal dust is formed in the crusher/classifier. Then, the hot gas carries the dust as a mixture out of the crusher/classifier to a filter.

The combination of the fine coal dust and heated nitrogen gas, termed the “gas/particulate mixture”, which includes steam, nitrogen, and pulverized fuel, dries the pulverized fuel as the hot nitrogen gas passes over and through the particles and fine coal dust, drying the coal.

The heated gas, particulate, and steam mixture can be injected into the bag filter housing slowly and at a slight vacuum through the bag filters. The residence time for the coal dust on the filters within the bag filter housing can be as short as 30 seconds, and the nitrogen passes through the filter bags with the steam. The bag filters in the vessel are pulsed to shake off the coal dust for about 1 second of every 30 seconds using at least one flow insertion wand for periodically pulsing each bag filter within the vessel.

The gas and steam mixture is removed from the bag filter housing using a gas blower which applies a small vacuum of about 0.1 bar to the filter. The gas blower acts like a vacuum to suction the gas. The blower increases the pressure of the nitrogen gas and steam mixture, permitting reuse of at least a portion of the gas and steam mixture while discharging of a portion.

The portion of the nitrogen gas and steam mixture to be reused is directed to the shell and tube heat exchanger, where it mixes with additional dry nitrogen gas to form, in the shell heat exchanger, a gas and steam heated mixture.

Dried pulverized coal can be continuously removed from the bottom of the bag filter housing, wherein the dried pulverized coal has a water content ranging from about 6% by weight to about 10% by weight of water.

This example enables fine coal feedstocks to be dried in a continuous manner and enables waste heat to be recycled and reused from the Fischer-Tropsch reactions, saving on the cost of gas and electricity, and conserving the use of fossil fuels for these reactions.

While these embodiments have been described with emphasis on the preferred embodiments, it should be understood that within the scope of the appended claims, the embodiments might be practiced other than as specifically described herein.

What is claimed is:

1. A method for using heat from a combustion turbine exhaust to dry fuel feedstocks, wherein the method comprises the steps of:
a. forming an initial nitrogen gas heated to a first temperature ranging from about 212 degrees Fahrenheit to about 350 degrees Fahrenheit forming a heated nitrogen gas;
b. conveying combustion turbine exhaust to an apparatus for forming a pulverized fuel;
c. mixing the heated nitrogen gas with the combustion turbine exhaust and a pulverized fuel in the apparatus for forming a pulverized fuel forming a gas/particulate mixture at a second temperature of at least 572 degrees Fahrenheit, wherein the gas/particulate mixture comprises nitrogen, steam, and pulverized fuel, and wherein the gas/particulate mixture has a ratio of gas to particulate ranging from 40:1 to 150:1 cubic feet of gas per pound of pulverized fuel;
d. using momentum of the gas/particulate mixture to convey the gas/particulate mixture to a filter and filtering the pulverized fuel from the gas/particulate mixture forming a stream of steam and nitrogen and a dried fuel feedstock; and
e. compressing the stream of steam and nitrogen and separating the stream of steam and nitrogen into a discharge stream and a recycle stream, wherein the recycle stream mixes with additional nitrogen to be used as the initial nitrogen gas for mixing with combustion turbine exhaust in a continuous process.

2. The method of claim 1, wherein the pulverized fuel has from 8% to about 10% absorbed water by weight.

3. The method of claim 1, wherein the pulverized fuel is a wet pulverized coal, a pulverized biomass, or combinations thereof.

4. The method of claim 3, wherein the combinations of wet pulverized coal and pulverized biomass comprise up to 20% pulverized biomass.

5. The method of claim 3, wherein the pulverized biomass comprises a member of the group consisting of: wood chips, switch grass, corn stover, bagasse, other leafy plant matter, or combinations thereof.

6. The method of claim 1, wherein the filtering of the dried fuel feedstock is done using multiple bag filters and at least one flow insertion wand for periodically pulsing each bag filter to remove the dried fuel feedstock.

7. The method of claim 1, wherein the heated nitrogen gas is passed through the pulverized fuel at a flow rate ranging from about 80,000 cubic feet to about 300,000 cubic feet per ton of pulverized fuel.

8. The method of claim 1, wherein the pulverized fuel has about 95% particulate smaller than about 400 microns in diameter and about 50% particulate smaller than about 200 microns in diameter.

9. The method of claim 1, further comprising the step of placing the pulverized fuel under a vacuum during heating.

10. The method of claim 1, further comprising using gravity to remove the dried fuel feedstock during filtration.

11. The method of claim 1, further comprising using a vacuum pump to remove the stream of steam and nitrogen from the filter.

12. The method of claim 1, further comprising the step of pulverizing a fuel to form the pulverized fuel.

13. The method of claim 1, further comprising the step of mixing the heated nitrogen gas with incinerator flue gas in the apparatus for forming a pulverized fuel, for start-up.

14. The method of claim 1, further comprising the step of limiting the oxygen content of the gas/particulate mixture by combusting a fuel in the combustion turbine exhaust, thereby depleting the oxygen content of the combustion turbine exhaust and raising the temperature of the gas/particulate mixture.

15. The method of claim 1, wherein the initial nitrogen gas is pre-heated using steam produced by a Fischer-Tropsch reaction process.

16. The method of claim 1, wherein the dry fuel feedstock comprises coal, biomass, or combinations thereof.
